(19) United States
(12) Patent Application Publication
(10) Pub. No.: US 2025/0048315 A1
(43) Pub. Date: Feb. 6, 2025

(54) Authorizing Sidelink (SL) Usage of a Positioning Reference Unit (PRU)

(71) Applicant: Telefonaktiebolaget LM Ericsson (publ), Stockholm (SE)

(72) Inventors: Ritesh Shreevastav, Upplands Väsby (SE); Åke Busin, Sollentuna (SE); Antonino Orsino, Kirkkonummi (FI)

(21) Appl. No.: 18/718,885

(22) PCT Filed: Dec. 21, 2022
(86) PCT No.: PCT/SE2022/051220

§ 371 Date: Jun. 12, 2024

Related U.S. Application Data
(60) Provisional application No. 63/298,488, filed on Jan. 11, 2022.

(51) Int. Cl. H04W 64/00; H04L 5/00; H04W 12/104; H04W 72/25

(52) U.S. Cl. CPC H04W 64/00; H04L 5/0048; H04W 12/104; H04W 72/25

(57) ABSTRACT

Embodiments include methods for a user equipment (UE) configured for sidelink (SL) communication in a radio access network (RAN). Such methods include receiving an indication of whether one or more proximate positioning reference units (PRUs) are trustworthy for positioning-related operations with UEs and based on the indication, determining that a first one of the PRUs is trustworthy for positioning-related operations with UEs. Such methods include, based on determining that the first PRU is trustworthy, establishing a SL with the first PRU and performing positioning-related operations with the first PRU via the SL. Other embodiments include complementary methods for a PRU and for a RAN node, as well as UEs. PRUS, and RAN nodes configured to perform such methods.

### TECHNICAL FIELD

The present disclosure relates generally to wireless communication networks, and more specifically to user equipment (UE) location determination based on sidelink (SL) communication with positioning reference units (PRUs) associated with a radio access network (RAN).

### BACKGROUND

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency 20) division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

Sidelink (SL) is a type of device-to-device (D2D) communication whereby UEs can communicate with each other directly rather than indirectly via a 3GPP RAN. The first 3GPP standardization of SL was in LTE Rel-12 targeting public safety use cases and proximity-based services (ProSe). Since then, a number of enhancements have been introduced to broaden the use cases that could benefit from D2D technology. For example, the D2D extensions in LTE Rel-14 and Rel-15 include supporting vehicle-to-everything (V2X) communication.

3GPP Rel-16 specifies the NR SL interface. NR Rel-16 SL targets advanced V2X services, which can be categorized into four use case groups: vehicles platooning, extended sensors, advanced driving, and remote driving. The advanced V2X services require a new SL in order to meet the stringent requirements in terms of latency and reliability. The NR SL is designed to provide higher system capacity and better coverage, and to allow for extension to support the future development of even more advanced V2X services and other related services. Broadcast, groupcast, and unicast transmissions are desirable for the services targeted by NR SL. In groupcast (or multicast), the intended receiver of a message consists of only a subset of the possible recipients in proximity to the transmitter, whereas a unicast message is intended for only one recipient in proximity to the transmitter. For example, in the platooning service there are certain messages that are only of interest of the members of the platoon, for which groupcast can be used. Unicast is a natural fit for use cases involving only a pair of vehicles.

Furthermore, NR SL is designed such that it is operable both with and without network coverage and with varying degrees of interaction between the UEs (user equipment) and the RAN, including support for standalone, network-less operation. For example, national security and public safety (NSPS) services often need to operate without (or with partial) RAN coverage, such as during indoor firefighting, forest firefighting, earthquake rescue, sea rescue, etc. Network coverage extension is a crucial enabler in these scenarios. 3GPP Rel-17 includes a study item for coverage extension for SL-based communication, including UE-to-network (U2N) relay for cellular coverage extension and UE-to-UE (U2U) relay for SL coverage extension. Additionally, improving performance of power-limited UEs (e.g., pedestrian UEs, first responder UEs, etc.) and improving performance using resource coordination are also important goals for the Rel-17 work. 3GPP standards provide various ways for positioning (e.g., determining the position of, locating, and/or determining the location of) UEs operating in 3GPP networks. In general, a positioning node configures the target device (e.g., UE) and/or a RAN node to perform one or more positioning measurements according to one or more positioning methods. For example, the positioning measurements can include timing (and/or timing difference) measurements on UE, network, and/or satellite transmissions. The positioning measurements are used by the target device, the RAN node, and/or the positioning node to determine the location of the target device.

NR Rel-16 positioning was developed based on network-transmitted positioning reference signals (PRS), which can provide added value in terms of enhanced location capabilities. For example, PRS transmission in low and high frequency bands (e.g., below and above 6 GHz) and use of massive antenna arrays provide additional degrees of freedom to substantially improve positioning accuracy.

One positioning enhancement being discussed for 3GPP Rel-17 and beyond is the use of positioning reference units (PRUs) in the network. A PRU is a network node or device, at a known location, which can transmit uplink (UL) signals and perform positioning measurements. In this manner, PRUs can help identify positioning errors and facilitate compensation for these errors in positions determined for UEs that are proximate in the network. PRUs are also expected to be enablers for SL-based positioning. For example, a UE without line of sight (i.e., non-LOS) to a network node (e.g., gNB) may use a PRU as a positioning reference.

### SUMMARY

Currently, UEs use PRUs at their own risk. For example, a UE cannot determine if an available PRU is from a malicious source that is trying to obtain location of users without their consent. The network also faces risk from malicious devices, e.g., that attempt to pose as PRUs while providing incorrect measurements and location information. This can create various problems, issues, and/or difficulties when the network uses information from such malicious PRUs in calibration location errors for legitimate UEs served by the network.

Embodiments of the present disclosure provide specific improvements to SL operation of UEs with PRUs, such as by providing, enabling, and/or facilitating solutions to overcome exemplary problems summarized above and described in more detail below.

Embodiments include methods (e.g., procedures) for a UE configured for SL communication in a radio access network (RAN). These exemplary methods can include receiving an indication of whether one or more proximate PRUs are trustworthy for positioning-related operations with UEs. These exemplary methods can also include, based on the indication, determining that a first one of the PRUs is trustworthy for positioning-related operations with UEs. These exemplary methods can also include, based on determining that the first PRU is trustworthy, establishing a SL with the first PRU and performing positioning-related operations with the first PRU via the SL.

In some embodiments, the indication is received from a RAN node via one of the following: a unicast message or an encrypted broadcast message. In other embodiments, the UE is out-of-coverage with respect to the RAN and the indication is received via SL from one or more peer UEs, each peer UE being in-coverage or out-of-coverage with respect to the RAN.

In some embodiments, the indication comprises respective identifiers associated with the one or more PRUs, with each identifier indicating that the associated PRU is trustworthy for positioning-related operations with UEs.

In other embodiments, the exemplary method can also include sending a SL discovery request indicating a need for positioning-related operations and receiving, from the first PRU, a responsive message including one or more identifiers associated with the first PRU. In some variants, the one or more identifiers include a PRU identifier (PRU ID) and a layer-2 SL identifier (SL L2 ID).

In some of these embodiments, these exemplary methods can also include sending the one or more identifiers associated with the first PRU to a RAN node (e.g., serving gNB). The indication is received from the RAN node in response to sending the one or more identifiers associated with the first PRU, and indicates that the first PRU is trustworthy based on having been authenticated. In some variants of these embodiments, the indication from the RAN node comprises a SL configuration for establishing a SL connection with the first PRU, which indicates that the first PRU is trustworthy for positioning-related operations with UEs. The SL is established with the first PRU based on the SL configuration.

In other of these embodiments, these exemplary methods can also include sending the one or more identifiers associated with the first PRU in a SL discovery message during a SL discovery procedure. The SL discovery message indicates that the SL discovery procedure is for determining whether the first PRU is trustworthy for positioning-related operations with UEs. In such case, the indication comprises respective indications received from one or more peer UEs in response to the SL discovery message.

In some variants of these embodiments, determining that the first PRU is trustworthy is based on a predetermined number or portion of the received indications indicating that the first PRU is trustworthy for positioning-related operations with UEs. In some further variants, the predetermined portion is all of the received indications.

In some embodiments, the positioning-related operations performed by the UE with the first PRU can include any of the following:
transmitting SL reference signals (RS) for measurement by the first PRU;
measuring SL RS transmitted by the first PRU;
sending positioning measurements to the first PRU via the SL; and
receiving positioning assistance data from the first PRU via the SL.

Other embodiments include methods (e.g., procedures) for a PRU configured for SL communication in a RAN. These exemplary methods can include performing authentication and connection establishment with the RAN or with a peer UE that is out-of-coverage with respect to the RAN. These exemplary methods can also include receiving from a UE a SL discovery request indicating a need for positioning-related operations and in response to the SL discovery request, sending to the UE one or more identifiers associated with the PRU. These exemplary methods can also include subsequently establishing a SL with the UE and performing positioning-related operations with the UE via the SL.

In some embodiments, the PRU is out-of-coverage with respect to the RAN and the authentication and connection establishment is performed with the RAN via a relay UE that is in-coverage with respect to the RAN. In some of these embodiments, performing authentication and connection establishment with the RAN comprises sending one of the following to the relay UE:
a plurality of messages associated with the authentication and connection establishment, to be forwarded by the relay UE to the RAN; or
an indication for the relay UE to create the plurality of messages associated with the authentication and connection establishment, and to send them to the RAN on behalf of the PRU.

In some embodiments, performing authentication and connection establishment with the RAN or with the peer UE that is out-of-coverage with respect to the RAN comprises sending the one or more identifiers associated with the PRU to the RAN or to the peer UE during the authentication or the connection establishment. In some embodiments, the one or more identifiers associated with the PRU include a PRU identifier (PRU ID) and a layer-2 SL identifier (SL L2 ID). In other embodiments, the one or more identifiers are temporary or local identifiers not assigned by the RAN, and these exemplary methods also include determining updated values for the temporary or local identifiers in response to one or more of the following:
expiration of a validity timer;
a SL discovery request from another UE;
a radio link failure (RLF) on the SL and/or on a link with the RAN;
an update request from the RAN or from the UE; and
initiation of a handover of the PRU to a different cell in the RAN.

In various embodiments, the positioning-related operations performed by the PRU with the UE can include any of the following:
transmitting SL RS for measurement by the UE;
measuring SL RS transmitted by the UE;
receiving positioning measurements from the UE via the SL; and
sending positioning assistance data to the UE via the SL.

Other embodiments include methods (e.g., procedures) for a RAN node configured to support SL communication between UEs. These exemplary method can include, for each of one or more PRUs, obtaining one or more identifiers associated with the PRU. These exemplary methods can also include transmitting in a unicast or encrypted broadcast message an indication of whether each of the PRUs has been authenticated for positioning-related operations with UEs. The indications for the respective PRUs are based on the identifiers associated with the respective PRUs.

In some embodiments, the indication comprises the one or more identifiers associated with each of the PRUs that is trustworthy for positioning-related operations with UEs. In some of these embodiments, each of the PRUs is trustworthy based on authentication of the PRU with the RAN or with a core network connected to the RAN.

In other embodiments, obtaining one or more identifiers associated with each of one or more PRUs includes receiving from a UE first and second identifiers associated with a first PRU. For example, the first and second identifiers can be a PRU ID and an SL L2 ID, in either order. In such embodiments, these exemplary methods can also include determining whether the first PRU is trustworthy based on a mapping between corresponding first and second identifiers for PRUs that have been authenticated for positioning-related operations with UEs.

In some of these embodiments, the indication is transmitted to the UE in a unicast message and when the first PRU is determined to be trustworthy for positioning-related operations with UEs, the indication comprises a SL configuration for establishing a SL connection between the UE and the first PRU. For example, the inclusion of the SL configuration can indicate that the first PRU is trustworthy (e.g., based on having been authenticated).

In various embodiments, each of the PRUs is authenticated for one or more of the following positioning-related operations with UEs:
transmitting SL RS for measurement by UEs;
measuring SL RS transmitted by UEs;
receiving positioning measurements from UEs via SL; and
sending positioning assistance data to UEs via SL.

Other embodiments include UEs (e.g., wireless devices, NSPS devices, etc.), PRUs, and RAN nodes (e.g., base stations, eNBs, gNBs, en-gNBs, etc.) configured to perform operations corresponding to any of the exemplary methods described herein. Other embodiments include non-transitory, computer-readable media storing program instructions that, when executed by processing circuitry, configure such UEs, PRUS, and RAN nodes to perform operations corresponding to any of the exemplary methods described herein.

These and other embodiments described herein provide techniques to ensure that the PRU usage is secure, such that networks and UEs first determine that a node claiming to be a PRU has been authenticated (or is otherwise trustworthy) before using the node/PRU for positioning-related operations. In this manner, embodiments avoid and/or prevent risks that malicious PRUs pose to both UEs and networks and generally improve the security of positioning-related procedures involving PRUs.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 illustrates a high-level views of an exemplary 5G/NR network architecture.

FIG. 2 shows an exemplary configuration of NR user plane (UP) and control plane (CP) protocol stacks.

FIG. 3 shows an exemplary arrangement of interfaces between two V2X UEs and a RAN.

FIG. 4 shows three exemplary network coverage scenarios for two UEs and a gNB serving a cell.

FIGS. 5-6 show exemplary SL UP and CP protocol stacks, respectively, including layer-2 (L2) UE-to-Network Relay (U2N).

FIG. 7 shows an exemplary protocol stack for layer-3 (L3) ProSe 5G U2N Relay.

FIG. 8 illustrates a high-level architecture for UE positioning in NR networks.

FIGS. 9-10 are signal flow diagrams that illustrates techniques for networks to identify authenticated PRUs for use by UEs, according to various embodiments of the present disclosure.

FIG. 11 shows a flow diagram of an exemplary method (e.g., procedure) for a UE (e.g., wireless device), according to various embodiments of the present disclosure.

FIG. 12 shows a flow diagram of an exemplary method (e.g., procedure) for a PRU, according to various embodiments of the present disclosure.

FIG. 13 shows a flow diagram of an exemplary method (e.g., procedure) for a RAN node (e.g., base station), according to various embodiments of the present disclosure.

FIG. 14 shows a communication system according to various embodiments of the present disclosure.

FIG. 15 shows a UE according to various embodiments of the present disclosure.

FIG. 16 shows a network node according to various embodiments of the present disclosure.

FIG. 17 shows host computing system according to various embodiments of the present disclosure.

FIG. 18 is a block diagram of a virtualization environment in which functions implemented by some embodiments of the present disclosure may be virtualized.

FIG. 19 illustrates communication between a host computing system, a network node, and a UE via multiple connections, at least one of which is wireless, according to various embodiments of the present disclosure.

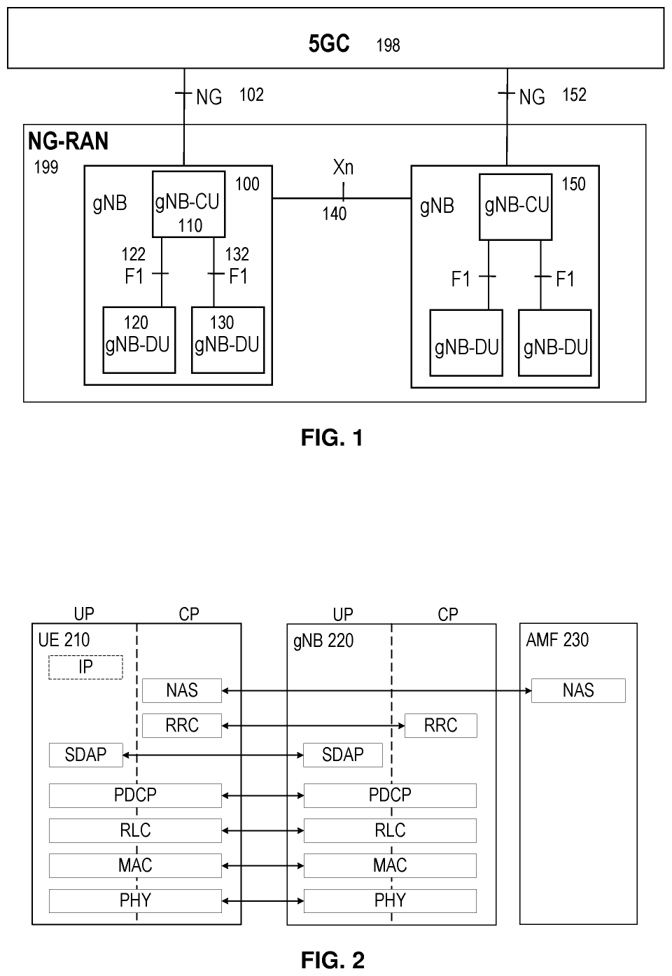

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Node: As used herein, the term “node” (without prefix) can be any type of node that can used in or with a wireless network (including RAN and/or core network), including a radio access node (or equivalent term), core network node, or wireless device. However, the term “node” may be limited to a particular type (e.g., radio access node) based on its specific characteristics in any given context.
Positioning measurements: As used herein, “positioning measurements” may include timing measurements (e.g., time difference of arrival, TDOA, RSTD, time of arrival, TOA, Rx-Tx, RTT, etc.), power-based measurements (e.g., RSRP, RSRQ, SINR, etc.), and/or identifier detection/measurement (e.g., cell ID, beam ID, etc.) that are configured for a positioning method (e.g., OTDOA, E-CID, etc.). UE positioning measurements may be reported to a network node or may be used for positioning purposes by the UE.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

FIG. 2 shows an exemplary configuration of NR user plane (UP) and control plane (CP) protocol stacks between a UE (210), a gNB (220), and an access and mobility management function (AMF, 230) in the 5GC. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active times, an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

DRX functionality is also used by RRC_CONNECTED UEs. This allows a UE to turn off at least some of its receiver circuitry when no incoming data is expected, which helps reduce the energy consumption. When configured, the DRX functionality controls the expected UE behavior in terms of reception and processing of transmissions. Similar to RRC_IDLE DRX, RRC_CONNECTED DRX includes an Active Time (also referred to as Active Time state or ACTIVE state), in which the UE is expected to receive and process incoming transmissions as appropriate. For example, the UE is expected to decode the downlink (DL) control channels, process grants, etc. When the UE is not in Active Time (i.e., the UE is in Inactive mode), there is no expectation by the network for the UE to receive and process transmissions.

Typically, UEs that are not in Active Time turn off some of their components and enter a reduced-energy (i.e., sleeping) mode. To ensure that the UE switches regularly to Active Time (i.e., wakes up), a DRX cycle is defined. This DRX cycle is controlled by two parameters: a periodicity, which controls how frequently the UE switches to Active Time; and a duration, which controls for how long the UE remains in active state each time it enters.

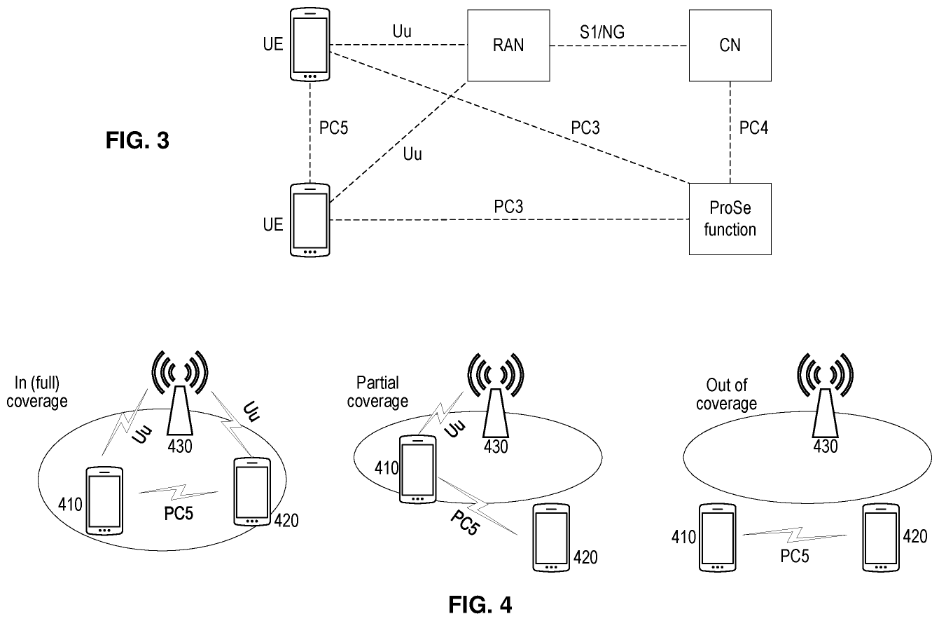

A vehicle-to-everything (V2X) UE can support unicast communication via the uplink/downlink radio interface (also referred to as “Uu”) to a 3GPP RAN, such as the LTE Evolved-UTRAN (E-UTRAN) or the NG-RAN. A V2X UE can also support SL unicast over the PC5 interface. FIG. 3 shows an exemplary arrangement of interfaces between two V2X UEs and a RAN. In addition to Uu and PC5 interfaces, the V2X UEs can communicate with a ProSe (PROximity-based SErvices) network function (NF) via respective PC3 interfaces. Communication with the ProSe NF requires a UE to establish a connection with the RAN, either directly via the Uu interface or indirectly via PC5 and another UE's Uu interface. The ProSe function provides the UE various information for network related actions, such as service authorization and provisioning of PLMN-specific information (e.g., security parameters, group IDs, group IP addresses, out-of-coverage radio resources, etc.).

FIG. 4 shows three exemplary network coverage scenarios for two UEs (410, 420) and a gNB (430) serving a cell. In the full coverage scenario (left), both UEs are in the coverage of the cell, such that they both can communicate with the gNB via respective Uu interfaces and directly with each other via the PC5 interface. In the partial coverage scenario (center), only one of the UEs is in coverage of the cell, but the out-of-coverage UE can still communicate with the gNB indirectly via the PC5 interface with the in-coverage UE. In the out-of-coverage scenario, both UEs can only communicate with each other via the PC5 interface.

In general, the term “SL standalone” refers to direct communication between two SL-capable UEs (e.g., via PC5) in which source and destination are the UEs themselves. In contrast, the term “SL relay” refers to indirect communication between a network node and a remote UE via a first interface (e.g., Uu) between the network node an intermediate (or relay) UE and a second interface (e.g., PC5) between the relay UE and the remote UE. In this case the relay UE is neither the source nor the destination.

In general, an “out-of-coverage UE” is one that cannot establish a direct connection to the network and must communicate via either SL standalone or SL relay. UEs that are in coverage can be configured (e.g., by a gNB) via RRC signaling and/or system information. Out-of-coverage UEs rely on a (pre-) configuration available in their SIMs. These pre-configurations are generally static but can be updated by the network when a UE is in coverage. A “peer UE” refers to a UE that can communicate with the out-of-coverage UE via SL standalone or SL relay (in which case the peer UE is also a relay UE).

As briefly mentioned above, two UE-based relay capabilities were studied for NR SL in Rel-17: UE-to-Network (U2N) relay, where a UE extends the network connectivity to another nearby UE by using direct communication; and UE-to-UE (U2U) relay, where a UE uses two direct communication links to connect two UEs in its proximity that otherwise are not able to communicate. U2N relay functionality is fundamental for network coverage extension for public safety in remote areas, for wearable devices tethering in commercial use cases (e.g., sensors, virtual reality headsets), etc. U2U relay functionality was not part of the LTE ProSe specification, and its inclusion on NR ProSe can be beneficial for public safety communications range extension for both in-network and off-network use cases. However, 3GPP decided not to include U2U relay in 3GPP Rel-17 work item.

LTE U2N relay functionality uses a Layer 3 (L3) architecture in which the relay of data packets via the PC5 interface is performed at the network layer, and UEs connected to a L3 U2N relay are transparent to the network. NR SL U2N relay uses two different architectures: a L3 architecture similar to LTE, and a newly defined architecture in which PC5 relaying occurs within Layer 2 (L2), over the RLC sublayer.

3GPP TR 23.752 (v2.0.0) section 6.6 describes L3-based U2N relay functionality (also referred to as “ProSe 5G U2N Relay”) that can be used for both public safety and commercial services. A ProSe 5G U2N Relay UE supports connectivity to the 5GS (i.e., NG-RAN and 5GC) for other UEs that have successfully established a PC5 link to the ProSe 5G U2N Relay UE.

3GPP TR 23.752 (v2.0.0) section 6.7 describes L2-based U2N relay functionality, which includes forwarding functionality that can relay any type of traffic over the PC5 interface between two UEs. A L2 U2N Relay UE supports connectivity to the 5GS (i.e., NG-RAN and 5GC) for other UEs that have successfully established a PC5 link to the L2 U2N Relay UE. A UE connected to a L2 U2N relay is expected to be seen by the network as a regular UE, as if it was directly connected to the network. This gives the network control of the connection and services but requires the definition of several new mechanisms not present or needed in the L3 architecture.

Unless expressly stated otherwise, the term “relay UE” (or “U2N relay UE”) will be used herein to refer to both a ProSe 5G U2N Relay UE and a L2 U2N Relay UE. Likewise, the term “remote UE” will be used to refer to a UE that has successfully established a PC5 link to a relay UE. Remote UEs can be located within NG-RAN coverage or outside of NG-RAN coverage.

Before a remote UE can communicate via a relay UE, the two UEs must discover each other. In NR SL, a ProSe direct discovery procedure can be used for a UE to discover or be discovered by other UE(s) in proximity over the PC5 interface (similar to LTE ProSe). The UE can discover other UE(s) with interested application(s) and/or interested group(s) using the ProSe direct discovery procedure. This feature aims to provide a common direct discovery procedure for discovering a 5G ProSe-enabled UE, a 5G ProSe U2N Relay UE, or a 5G ProSe UE-to-UE (U2U) Relay UE.

Discovery can also take place on L2 in the case of L2 U2N relay UEs. A UE connected to a L2 U2N relay is expected to be seen by the network as a regular UE, as if it was directly connected to the network. This gives the network control of the connection and services but requires definition of several new mechanisms not present or needed in the L3 architecture.

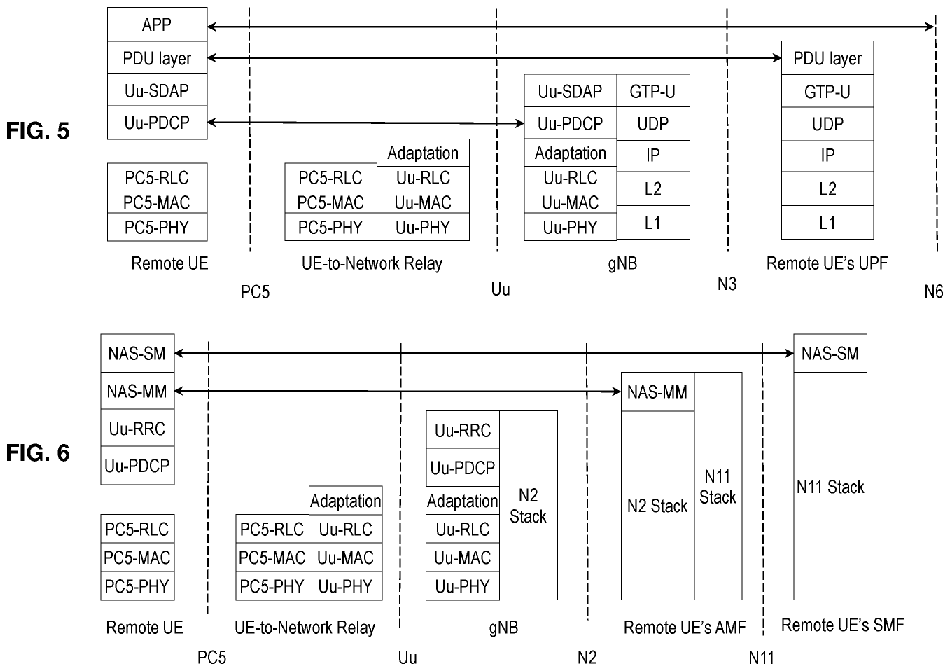

FIG. 5 illustrates an exemplary user plane (UP) SL protocol stack for a protocol data unit (PDU) Session, including a L2 U2N Relay UE. Below the application (APP) layer, the PDU layer carries data between the remote UE and the user plane function (UPF) in the 5GC, as part of the PDU session. In contrast, the PDCP layer is terminated at the remote UE and the gNB, and the L2 relay function is below PDCP. One consequence is that user data security is ensured between the remote UE and the gNB without exposing user data at the relay UE.

The Adaptation layer between the L2 U2N Relay UE and the gNB is able to differentiate between Uu bearers of a particular remote UE. Different Remote UEs and different Uu bearers of the Remote UE are indicated by additional information (e.g., UE IDs and bearer IDs) included in adaptation layer header that is added to each PDCP PDU. The adaptation layer can be considered as part of PDCP sublayer or a separate new layer between PDCP sublayer and RLC sublayer.

When both the remote UE and the L2 U2N Relay UE are in RRC_IDLE or RRC_INACTIVE states and there is incoming DL traffic for the remote UE, the network will page the remote UE. The L2 U2N relay UE monitors for this paging and informs the remote UE that there is incoming DL traffic. Both the remote UE and the L2 U2N Relay UE establish/resume their RRC connections to the gNB and the remote UE's incoming DL traffic is transferred from the gNB to the remote UE transparently via the L2 U2N Relay UE.

FIG. 6 illustrates an exemplary control plane (CP) SL protocol stack for non-access stratum (NAS) messages, including a L2 U2N Relay UE. The NAS connection is between the remote UE and the AMF (for NAS-MM) and a session management function (SMF, for NAS-SM) in the 5GC. The NAS messages are transparently transferred between the remote UE and 5G-AN via the relay UE. In particular, the relay UE forwards SRB messages without any modification. Moreover, the relay UE uses the same protocol stack for forwarding both CP messages and UP PDUs, as illustrated in FIGS. 5-6.

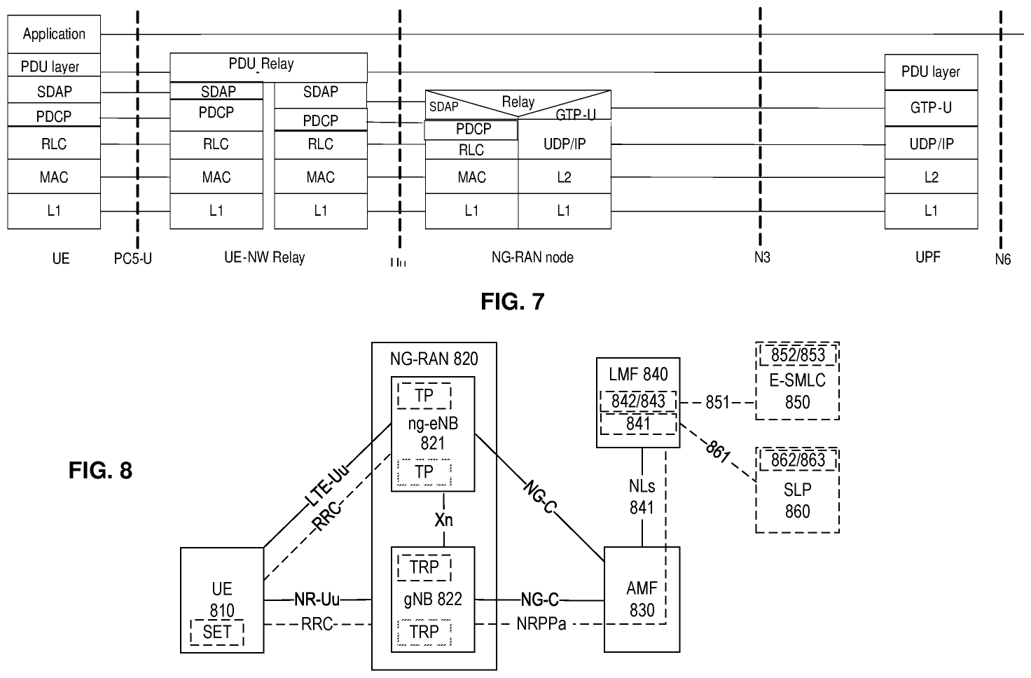

FIG. 7 shows an exemplary protocol stack for L3 ProSe 5G U2N Relay, as further described in 3GPP TR 23.752. The ProSe 5G U2N Relay shall relay UL and DL unicast traffic between the Remote UE and the network (e.g., NG-RAN). One-to-one Direct Communication is used between Remote UEs and ProSe 5G U2N Relays for unicast traffic as specified in solutions for Key Issue #2 in 3GPP TR 23.752. The ProSe U2N Relay provides a generic function that can relay any IP, Ethernet, or unstructured traffic at the PDU layer. Furthermore, the remote UE is invisible to the 5GC, i.e., it does not have its own context and PDU session in the 5GC and its traffic is forwarded in relay UE's PDU session. For IP PDU Session Type and IP traffic over PC5 reference point, the L3 U2N relay UE allocates IPV6 prefix or IPv4 address for the remote UE.

In case the L3 U2N relay UE is in in RRC_IDLE or RRC_INACTIVE state and there is incoming DL traffic for the remote UE, the network will page the L3 U2N relay UE. The L3 U2N relay UE then establishes/resumes its RRC connection, and then forwards the remote UE's traffic received from the network.

Various identities or identifiers are used to support NR SL communications. For example, a Source Layer-2 ID identifies a sender of SL data. The Source Layer-2 ID is 24 bits long and is split in the MAC layer into two bit strings. The eight (8) least significant bits (LSB) is used in physical layer (PHY) SL control information (SCI) to identify the sender and is used for filtering of packets at the PHY of the receiver. The 16 most significant bits (MSB) are carried in the MAC-layer header and are used for filtering of packets at the MAC layer of the receiver. Likewise, the Destination Layer-2 ID identifies the intended recipient of the data. Like the Source Layer-2 ID, it includes eight (8) LSBs used in the sender/receiver PHY layers and 16 MSBs used in the sender/receiver MAC layers.

Another identifier is the PC5 Link ID, which uniquely identifies a PC5 unicast link used by a UE during the link's lifetime. For example, the PC5 Link ID is used to indicate to upper layers the particular PC5 unicast link in which SL radio link failure (RLF) was declared and the corresponding PC5-RRC connection was released.

As briefly mentioned above, 3GPP standards provide various ways for positioning (e.g., determining the position of, locating, and/or determining the location of) UEs operating in 3GPP networks. The following positioning methods are supported in NR:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS. The UE receives and measures signals transmitted by GNSS satellites (e.g., GPS), supported by assistance information provided to the UE by a positioning node.
OTDOA (Observed Time Difference of Arrival). The UE receives and measures DL RS (e.g., PRS) transmitted by the RAN, supported by assistance information provided to the UE by a positioning node.
UTDOA (Uplink TDOA). The UE transmits UL RS (e.g., SRS) that are detected and measured by RAN nodes at known positions. These measurements are forwarded to a positioning node for multilateration.
Multi-RTT: Both UE and RAN nodes compute Rx-Tx time differences, with the results being combined by a positioning node to find the UE position based upon round trip time (RTT) calculation.
DL angle of departure (DL-AoD): RAN node or positioning node calculates the UE angular position based upon UE DL RSRP measurement results (e.g., of PRS transmitted by RAN nodes).
UL angle of arrival (UL-AoA): RAN node calculates the UL AoA based upon measurements of a UE's UL SRS transmissions.

In addition to these methods, a UE can also perform positioning measurements (and optionally calculate position) based on WLAN signals, Bluetooth signals, terrestrial beacon system (TBS) signals, and UE sensors (e.g., barometric pressure, accelerometer, etc.).

Additionally, one or more of the following positioning modes can be utilized in each of the positioning methods listed above:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.

The detailed assistance data may include information about network node locations, beam directions, etc. The assistance data can be provided to the UE via unicast or via broadcast.

FIG. 8 is a block diagram illustrating a high-level architecture for supporting UE positioning in NR networks. NG-RAN 820 can include nodes such as gNB 822 and ng-eNB 821. Each ng-eNB may control several transmission points (TPs), such as remote radio heads. Similarly, each gNB may control several transmission/reception points (TRPs).

In addition, the NG-RAN nodes communicate with an Access and Mobility Management Function (AMF) 830 in the 5GC via respective NG-C interfaces (both of which may or may not be present), while AMF 830 communicates with a location management function (LMF) 840 communicate via an NLs interface 841. LMF supports various functions related to UE positioning, including location determination for a UE, obtaining DL location measurements or a location estimate from the UE, obtaining UL location measurements from the NG RAN, and obtaining non-UE associated assistance data from the NG RAN.

In addition, positioning-related communication between UE 810 and the NG-RAN nodes occurs via the RRC protocol, while positioning-related communication between NG-RAN nodes and LMF occurs via an NRPPa protocol. Optionally, the LMF can also communicate with an E-SMLC 850 and a SUPL 860 in an LTE network via communication interfaces 851 and 861, respectively. Communication interfaces 851 and 861 can be implemented according to standardized protocols, proprietary protocols, or a combination thereof.

LMF 840 can also include, or be associated with, various processing circuitry 842, by which the LMF performs various operations described herein. Processing circuitry 842 can include similar types of processing circuitry as described herein in relation to other network nodes (see, e.g., description of FIGS. 16 and 18). LMF 840 can also include, or be associated with, a non-transitory computer-readable medium 843 storing instructions (also referred to as a computer program program) that can facilitate the operations of processing circuitry 842. Medium 843 can include similar types of computer memory as described herein in relation to other network nodes (see, e.g., description of FIGS. 16 and 18). Additionally, LMF 840 can include various communication interface circuitry 841 (e.g., Ethernet, optical, and/or radio transceivers) that can be used, e.g., for communication via the NLs interface. For example, communication interface circuitry 841 can be similar to other interface circuitry described herein in relation to other network nodes (see, e.g., description of FIGS. 16 and 18).

Similarly, E-SMLC 850 can also include, or be associated with, various processing circuitry 852, by which the E-SMLC performs various operations described herein. Processing circuitry 852 can include similar types of processing circuitry as described herein in relation to other network nodes (see, e.g., description of FIGS. 16 and 18). E-SMLC 850 can also include, or be associated with, a non-transitory computer-readable medium 853 storing instructions (also referred to as a computer program program) that can facilitate the operations of processing circuitry 852. Medium 853 can include similar types of computer memory as described herein in relation to other network nodes (see, e.g., description of FIGS. 16 and 18). E-SMLC 850 can also have communication interface circuitry that is appropriate for communicating via interface 851, which can be similar to other interface circuitry described herein in relation to other network nodes (see, e.g., description of FIGS. 16 and 18).

Similarly, SLP 860 can also include, or be associated with, various processing circuitry 862, by which the SLP performs various operations described herein. Processing circuitry 662 can include similar types of processing circuitry as described herein in relation to other network nodes (see, e.g., description of FIGS. 16 and 18). SLP 860 can also include, or be associated with, a non-transitory computer-readable medium 863 storing instructions (also referred to as a computer program program) that can facilitate the operations of processing circuitry 862. Medium 863 can include similar types of computer memory as described herein in relation to other network nodes (see, e.g., description of FIGS. 16 and 18). SLP 860 can also have communication interface circuitry that is appropriate for communicating via interface 861, which can be similar to other interface circuitry described herein in relation to other network nodes (see, e.g., description of FIGS. 16 and 18).

In a typical operation, the AMF can receive a request for a location service associated with a particular target UE from another entity (e.g., a gateway mobile location center, GMLC), or the AMF can initiate a location service on behalf of a particular target UE (e.g., for an emergency call by the UE). The AMF then sends a location services (LS) request to the LMF. The LMF processes the LS request, which may include transferring assistance data to the target UE to assist with UE-based and/or UE-assisted positioning; and/or positioning of the target UE. The LMF then returns the result of the LS (e.g., a position estimate for the UE and/or an indication of any assistance data transferred to the UE) to the AMF or to another entity (e.g., GMLC) that requested the LS.

An LMF may have a signaling connection to an E-SMLC, enabling the LMF to access information from E-UTRAN, e.g., to support E-UTRA OTDOA positioning by obtaining measurements made by a target UE based on DL PRS. An LMF can also have a signaling connection to an SLP, the LTE entity responsible for user-plane positioning.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either CP or UP protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is used as transport for LPP and NRPPa messages over the NG-C interface. NGAP is also used to instigate and terminate NG-RAN-related positioning procedures.

LPP/NRPP are used to deliver messages such as positioning capability request, OTDOA positioning measurements request, and OTDOA assistance data to the UE from a positioning node (e.g., location server). LPP/NRPP are also used to deliver messages from the UE to the positioning node including, e.g., UE capability, UE measurements for UE-assisted OTDOA positioning, UE request for additional assistance data, UE configuration parameter(s) to be used to create UE-specific OTDOA assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that can be used for OTDOA positioning measurements by the UE.

As briefly mentioned above, network-based positioning reference units (PRUs) are being discussed in 3GPP as a positioning enhancement for Rel-17 and beyond. A PRU is a network node or device, at a known location, which can transmit UL signals and perform positioning measurements (e.g., on DL signals). In this manner, PRUs can help identify positioning errors and facilitate compensation for these errors in positions determined for UEs that are proximate in the network. PRUs are also expected to be enablers for SL-based positioning. For example, a UE without line of sight (i.e., non-LOS) to a network node (e.g., gNB) may use a PRU as a positioning reference.

PRUs may support some of the Rel-16 positioning functionalities of UEs such as providing positioning measurements (e.g., RSTD, RSRP, Rx-Tx time differences) of DL PRS, transmitting the UL SRS signals for positioning, etc. An LMF may request a PRU to provide its known location and, if known, the PRUs antenna orientation or direction.

Currently, UEs use PRUs at their own risk. For example, a UE cannot determine if an available PRU is from a malicious source that is trying to obtain location of users without their consent and/or provide incorrect or misleading positioning information to UEs. This can cause serious problems for critical applications (e.g., NSPS) or emergency calls. The network also faces risk from malicious devices, e.g., that attempt to pose as PRUs while providing incorrect measurements and location information. This can create various problems, issues, and/or difficulties when the network uses information from such malicious PRUs in calibration location errors for legitimate UEs served by the network.

Accordingly, embodiments of the present disclosure address these and other problems, issues, and/or difficulties by providing techniques to ensure that the PRU usage is secure, such that networks and UEs first determine that a node claiming to be a PRU has been authenticated (or is otherwise trustworthy) before using the node/PRU for positioning-related operations. In this manner, embodiments avoid and/or prevent the various problems, issues, and/or difficulties discussed above and generally improve security of positioning-related procedures involving PRUs.

In some embodiments, the network provides and/or advertises PRU IDs associated with PRUs that have been authenticated. These IDs are provided via unicast or via encrypted broadcast signaling (e.g., SI block, SIB). In this manner, the network controls which PRUs that UEs use for positioning-related operations (e.g., DL PRS measurement, UL SRS transmission, assistance data, etc.). Based on this information, SL UEs can select valid PRUs to connect to (i.e., via PC5 link) before using these nodes as PRUs for positioning-related operations.

In other embodiments, a SL UE may select and/or discover a PRU to connect to (e.g., via PC5 link) without knowing in advance whether the PRU is trustworthy. In such case, the network may know the PRU ID but is not aware of the SL L2 ID selected by the PRU for SL transmissions, since the SL L2 ID is selected by the UE itself (PRU in this case). In these embodiments, the PRU authenticates itself towards the network via a NAS registration request procedure and establishes security via the Uu connection with the network.

In these embodiments, before establishing the PC5 link with the selected PRU, the SL UE informs the network about the PRU's ID and SL L2 ID. This can be done, for example, during authentication with the network. The network maintains a mapping between SL L2 ID and PRU ID and can check whether the PRU indicated by the SL UE has been authenticated. If so, the network sends the UE a SL configuration for establishing a PC5 link between the UE and the PRU, which indicates that the PRU is trustworthy based on having been authenticated. Otherwise, the network informs the UE that the PRU is not trustworthy and the UE can select another PRU for the positioning-related procedure (and repeat sending the new PRU's information to the network for authorization). In some variants, the network may also broadcast (e.g., in an encrypted SIB) the mapping between the PRU IDs and SL L2 IDs of authenticated PRUs, and SL UEs can receive this information while operating in RRC_IDLE and RRC_INACTIVE states.

As mentioned above, a PRU can be a dedicated node (e.g., deployed when needed) used for positioning purposes or it can be a UE-like device with positioning capabilities. In both cases, before the PRU can operate in a particular network, it should perform a NAS Registration Request procedure and relative authentication procedure in a similar manner as other UEs. However, there are various way in which registration and authentication can be done, depending on whether the PRU is in-coverage or out-of-coverage with respect to a particular gNB.

In case the PRU is in coverage, the NAS Registration Request procedure can be initiated by the PRU itself. In one alternative, a new establishment cause used during the RRC setup/resume procedure can be defined, e.g., “positioning”, “pru”, “pos-service”, “pru-service”, or the like. This new establishment cause used for the PRU is also used on the NAS layer during the NAS Registration Request procedure.

In case the PRU is out-of-coverage, the PRU cannot send NAS or RRC messages directly to the network. In such a case, the procedure for registration request, authentication, and RRC establishment can be done by a proximate UE on behalf of the PRU. In this case, the PRU first performs SL discovery to identify nearby UEs and when doing so, advertises that the PRU is looking for and/or can provide positioning-related services. In this case, only nearby UEs interested in positioning-related services will reply with a positive acknowledgement to the discovery message of the PRU.

After a suitable UE has been discovered by the PRU, if this UE is in coverage of a gNB, it will be a relay UE responsible for forwarding NAS and RRC messages between the PRU and the network. In some embodiments, the PRU generates the NAS Registration Request message and the RRC setup/resume message and these are forwarded by the relay UE to the network.

In other embodiments, the PRU may send to the relay UE an indication that the NAS Registration Request message and the RRC setup/resume message should be triggered to the network on behalf of the PRU. In such case, the relay UE generates those messages and sends them to the network on behalf of the PRU. When sending the NAS and RRC messages to the network, the relay UE may indicate that those messages are on behalf of a PRU. Additionally, a new establishment cause used when sending these messages can be defined, e.g., “positioning”, “pru”, “pos-service”, “pru-service”, or the like.

If the suitable UE is out-of-coverage with respect to the RAN, there is no possibility for the PRU to perform the NAS Registration Request procedure or the RRC establishment (setup or resume) procedure since it will have no direct connection via the network. In such a case, the authentication of the PRU can be done by the suitable UE itself based on the pre-configured (e.g., in SIM card) or pre-defined (e.g., in 3GPP specification) set of parameters. In this scenario, there is no RAN involvement (as it cannot be reached) and the PRU only uses SL technology for positioning-related operations with other SL UEs. This also means that the LMF is not reachable by the PRU to provide measurements for positioning of the SL UEs.

Once a PRU has been authenticated and determined to be trustworthy by the network, the network must provide such information to UEs that may want to use the PRU for positioning-related operations. This can be done in various ways, as described below.

In some embodiments, the network advertises IDs of authenticated PRUs. These IDs can be provided via unicast or via encrypted broadcast signaling (e.g., SI block, SIB). In this manner, the network controls which PRUs that UEs may use for positioning-related operations. Based on this information, SL UEs can select trustworthy (in this case, authenticated) PRUs to connect to via PC5 link before using these nodes as PRUs for positioning-related operations.

A gNB can obtain a list of authenticated PRU IDs from the AMF, the LMF, or a unified data management (UDM) function in the 5GC via the corresponding interface and/or protocol described above. Once a PRU has performed an authentication with the AMF, the AMF or the UDM may store the PRU's SL L2 ID and International Mobile Subscriber Identity (IMSI). Alternatively, a gNB may also store the PRU's SL L2 ID together with a gNB-related identifier such as Cell Radio Network Temporary Identifier (C-RNTI) or SL-RNTI.

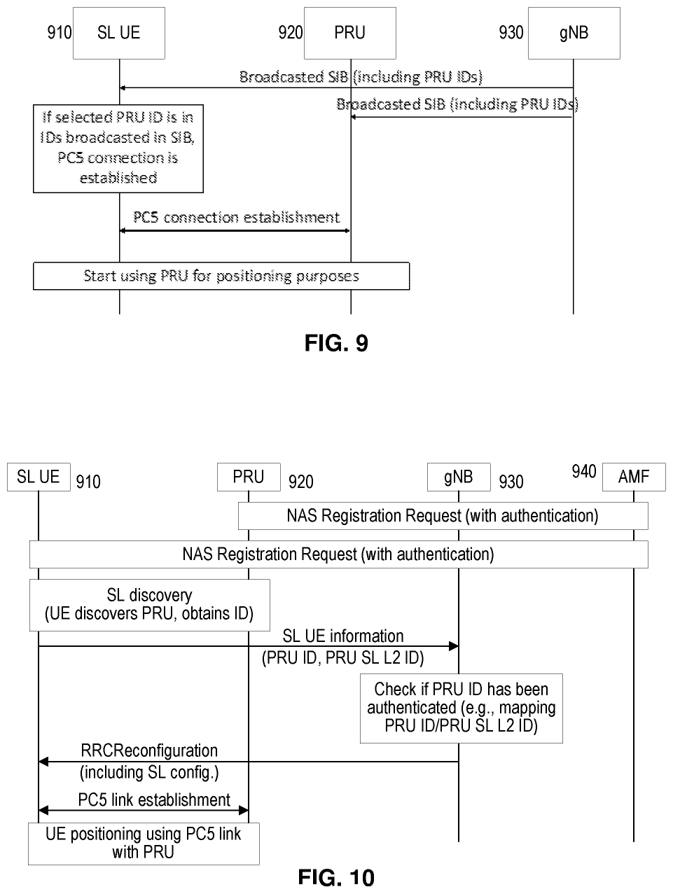

FIG. 9 is a signal flow diagram that illustrates an example of these embodiments. In this example, the gNB (930) initially broadcasts in an encrypted SIB the authenticated PRU IDs associated with a cell served by the gNB. This broadcast is received by the PRU (920) and the SL UE (910), which are proximate in the cell. At least the SL UE stores the authenticated PRU IDs indicated by the broadcast.

Subsequently, the SL UE discovers the PRU, which provides its PRU ID to the SL UE. The SL UE verifies that the received PRU ID matches one of the stored authenticated PRU IDs obtained from the SIB. Based on this verification, the SL UE establishes a PC5 link with the PRU and the performs positioning-related operations with the PRU (e.g., performs ranging measurements, receives positioning assistance data, etc.) via the PC5 link.

In other embodiments, a SL UE may select and/or discover a PRU to connect to (e.g., via PC5 link) without knowing in advance whether the PRU is trustworthy for positioning-related operations. FIG. 10 is a signal flow diagram that illustrates an example of these embodiments.

In these embodiments, the PRU (920) authenticates itself towards the network via a NAS Registration Request procedure with the AMF (940) and establishes security via its Uu connection with the network. During the authentication, the network can obtain from the PRU a SL L2 ID selected by the PRU. The SL UE (910) also authenticates itself towards the network via a NAS Registration Request procedure with the AMF and establishes security via its Uu connection with the network.

Subsequently, the SL UE discovers the PRU in association with a positioning-related procedure and obtains the PRU's ID and SL L2 ID. Before establishing the PC5 link with the PRU, the SL UE informs the network about the PRU's ID and SL L2 ID. The gNB (930) maintains a mapping between SL L2 ID and PRU ID (i.e., based on previous PRU authentication) and checks whether the PRU indicated by the SL UE has been authenticated.

If the gNB determines that the PRU has been authenticated, the network sends the UE an RRCReconfiguration message that includes a SL configuration for establishing a PC5 link between the UE and the PRU, which indicates that the PRU is trustworthy based on having been authenticated. The SL establishes a PC5 link with the PRU and the performs positioning-related operations with the PRU (e.g., performs ranging measurements, receives positioning assistance data, etc.) via the PC5 link.

If the gNB determines that the PRU has not been authenticated, the gNB informs the UE so that the UE can select another PRU for the positioning-related operations (and repeat sending the new PRU's information to the network for authorization). In some variants, the network may also broadcast (e.g., in an encrypted SIB) the mapping between the PRU IDs and SL L2 IDs of the authenticated PRUs, and SL UEs can receive this information while operating in RRC_IDLE and RRC_INACTIVE states.

In the above-described embodiments, when a SL UE discovers (or try to connect directly to) a PRU, the PRU sends the SL UE its PRU ID assigned previously by the network. To reduce the risk of Distributed Denial of Service (DDOS) attacks over a radio bearer or channel that may be used for data or control signaling, a new SL signaling radio bearer (SL-SRB) may be defined and used for positioning-related purposes such as sending PRU ID. This new SL-SRB may also have some information predefined.

When an out-of-coverage UE discovers a PRU, the UE cannot inquire to the network about whether the discovered PRU has been authenticated. Embodiments described below provide techniques for out-of-coverage UEs to determine the trustworthiness of the PRU, at least to some degree.

In some embodiments, when performing a SL discovery procedure, a UE may include a PRU ID in the discovery message and indicate that this discovery procedure is being done to verify whether the PRU associated with that PRU ID is trustworthy for positioning-related operations with UEs. Once an in-coverage peer UE has been discovered, this peer UE can receive from its serving gNB a list of proximate authenticated PRUs and either: 1) forward the list to the UE that provided the PRU ID; or 2) check whether the PRU ID is on the list and inform the UE about the result (i.e., whether the PRU ID is associated with an authenticated PRU).

Alternately, the in-coverage peer UE can send the PRU ID to its serving gNB, which will respond with a SL configuration for connecting to the PRU if it determines the PRU ID is associated with an authenticated PRU. The peer UE can then forward the SL configuration to the UE that provided the PRU ID, which can then use it to establish and PC5 link with the PRU and perform positioning-related operations in a similar manner as described above.

In other embodiments, when the discovered peer UE is out-of-coverage with respect to the RAN, the peer UE may base its indication of whether the PRU ID is associated with a trustworthy PRU on one or more of the following:
whether the peer UE previously used the PRU for positioning-related operations;
whether the peer UE previously performed NAS registration request, authentication, or RRC establishment (setup or resume) on behalf of the PRU; and
whether any (or some portion) of proximate UEs have indicated that the selected PRU is trustworthy, e.g., during a discovery procedure in which the peer UE forwarded the PRU ID in a discovery message such as described above.

In other embodiments, when more than one peer UE was discovered by the UE that wants to use the selected PRU, the UE can consider the PRU as trustworthy only when the UE receives a positive indication (i.e., of trustworthiness) from at least a threshold number or portion of the discovered peer UEs. In a specific example, the threshold portion can be all of the discovered peer UEs, such that a single negative indication will cause to UE to consider the PRU to be non-trustworthy.

Even if a SL connection between a UE and a peer UE is encrypted and integrity protected, there can be a security risk in revealing to another UE information that are only known (or assigned) by the network. For example, the other UE may use this information to tamper NAS and/or RRC messages and in a malicious way.

To address this issue, in some embodiments, IDs and information that are assigned by the network are not disclosed over the SL connection. Rather, a PRU can send a temporary or local ID to a UE that wants to use the PRU for positioning-related operations. This temporary or local ID can be assigned by the network when the PRU perform the NAS Registration Request or RRC establishment (setup or resume) procedures. Alternatively, the temporary or local ID can be assigned by a UE that authenticates the PRU when both the PRU and the UE are out-of-coverage. Nevertheless, the temporary or local ID cannot be used for an extended duration and should be updated frequently to avoid becoming functionally equivalent to a permanent or regular ID.

In various embodiments, the PRU can initiate a procedure to update a temporary or local ID based on one or more of the following conditions:
an ID validity timer has expired;
the PRU received a request for positioning-related operations from a different UE;
a RLF happen occurred between the PRU and a UE or between the PRU and the network;
signaling received from the serving gNB or a UE via SL (e.g., request to change ID);
handover procedure has been triggered, such that the serving gNB and/or the relay UE sending NAS and RRC messages on behalf of the PRU has changed; and
other PRU mobility events.

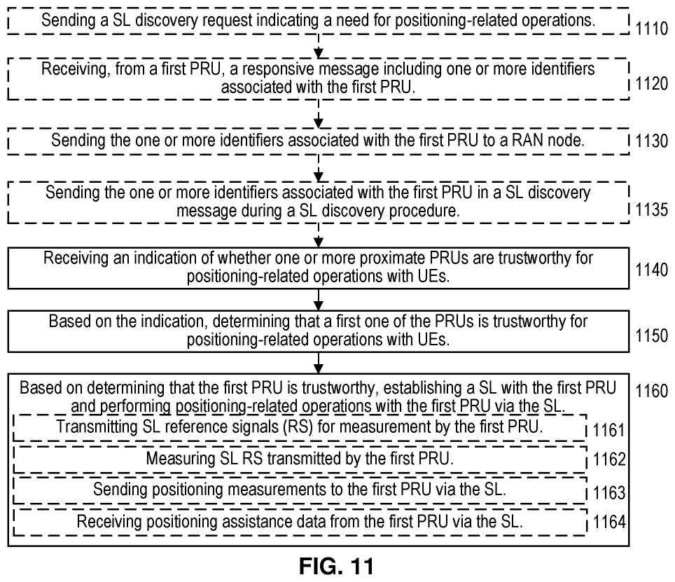

Various features of the embodiments described above correspond to various operations illustrated in FIGS. 11-13, which show exemplary methods (e.g., procedures) for a UE, a PRU, and a RAN node, respectively. In other words, various features of the operations described below correspond to various embodiments described above. Furthermore, the exemplary methods shown in FIGS. 11-13 can be used cooperatively to provide various benefits, advantages, and/or solutions to problems described herein. Although FIGS. 11-13 show specific blocks in particular orders, the operations of the exemplary methods can be performed in different orders than shown and can be combined and/or divided into blocks having different functionality than shown. Optional blocks or operations are indicated by dashed lines.

In particular, FIG. 11 shows an exemplary method (e.g., procedure) for a UE configured for SL communication in a radio access network (RAN), according to various embodiments of the present disclosure. The exemplary method can be performed by a UE (e.g., wireless device, etc.) such as described elsewhere herein.

The exemplary method can include the operations of block 1140, where the UE can receive an indication of whether one or more proximate PRUs are trustworthy for positioning-related operations with UEs. The exemplary method can also include the operations of block 1150, where the UE can, based on the indication, determine that a first one of the PRUs is trustworthy for positioning-related operations with UEs. The exemplary method can also include the operations of block 1160, where based on determining that the first PRU is trustworthy, the UE can establish a SL with the first PRU and perform positioning-related operations with the first PRU via the SL.

In some embodiments, the indication is received from a RAN node via one of the following: a unicast message or an encrypted broadcast message. In other embodiments, the UE is out-of-coverage with respect to the RAN and the indication is received via SL from one or more peer UEs, each being in-coverage or out-of-coverage with respect to the RAN.

In some embodiments, the indication comprises respective identifiers associated with the one or more PRUs, with each identifier indicating that the associated PRU is trustworthy for positioning-related operations with UEs. FIG. 9 shows an example of these embodiments.

In other embodiments, the exemplary method can also include the operations of blocks 1110-1120, where the UE can send a SL discovery request indicating a need for positioning-related operations and receive, from the first PRU, a responsive message including one or more identifiers associated with the first PRU. In some variants, the one or more identifiers include a PRU identifier (PRU ID) and a layer-2 SL identifier (SL L2 ID).

In some of these embodiments, the exemplary method can also include the operations of block 1130, where the UE can send the one or more identifiers associated with the first PRU to a RAN node (e.g., serving gNB). The indication is received from the RAN node in block 1140 in response to sending the one or more identifiers associated with the first PRU in block 1130, and indicates that the first PRU is trustworthy based on having been authenticated (e.g., by the RAN node or by the CN). FIG. 10 shows an example of these embodiments.

In some variants of these embodiments, the indication from the RAN node comprises a SL configuration for establishing a SL connection with the first PRU, which indicates that the first PRU is trustworthy (e.g., based on having been authenticated) for positioning-related operations with UEs. The SL is established with the first PRU in block 1160 based on the SL configuration.

In other of these embodiments, the exemplary method can also include the operations of block 1135, where the UE can send the one or more identifiers associated with the first PRU in a SL discovery message during a SL discovery procedure. The SL discovery message indicates that the SL discovery procedure is for determining whether the first PRU is trustworthy for positioning-related operations with UEs. In such case, the indication comprises respective indications received from one or more peer UEs in response to the SL discovery message.

In some variants of these embodiments, determining that the first PRU is trustworthy (e.g., in block 1150) is based on a predetermined number or portion of the received indications indicating that the first PRU is trustworthy for positioning-related operations with UEs. In some further variants, the predetermined portion is all of the received indications.

In various embodiments, the positioning-related operations performed by the UE in block 1160 can include any of the following (with associated sub-block numbers):
(1161) transmitting SL reference signals (RS) for measurement by the first PRU;
(1162) measuring SL RS transmitted by the first PRU;
(1163) sending positioning measurements to the first PRU via the SL; and
(1164) receiving positioning assistance data from the first PRU via the SL.

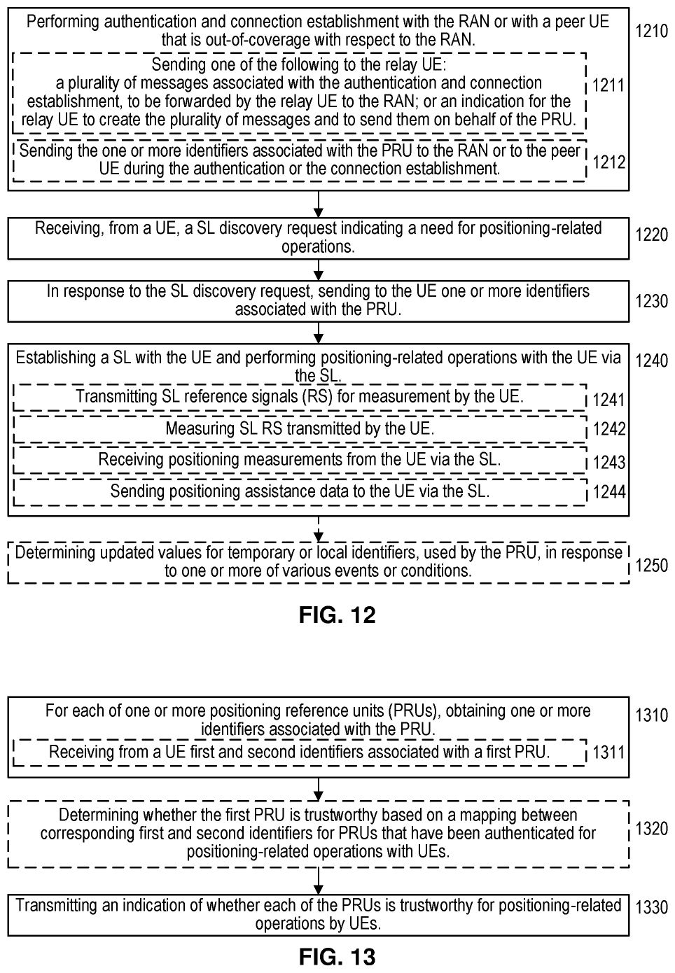

In addition, FIG. 12 shows an exemplary method (e.g., procedure) for a PRU configured for SL communication in a RAN, according to various embodiments of the present disclosure. The exemplary method can be performed by a PRU such as described elsewhere herein.

The exemplary method can include the operations of block 1210, where the PRU can perform authentication and connection establishment with the RAN or with a peer UE that is out-of-coverage with respect to the RAN. The exemplary method can also include the operations of blocks 1220-1230, where the PRU can receive from a UE a SL discovery request indicating a need for positioning-related operations and in response to the SL discovery request, send to the UE one or more identifiers associated with the PRU. The exemplary method can also include the operations of block 1240, where the PRU can subsequently establish a SL with the UE and perform positioning-related operations with the UE via the SL.

In some embodiments, the PRU is out-of-coverage with respect to the RAN and the authentication and connection establishment is performed with the RAN via a relay UE that is in-coverage with respect to the RAN. In some of these embodiments, performing authentication and connection establishment with the RAN in block 1210 includes the operations of sub-block 1211, where the PRU sends one of the following to the relay UE:
a plurality of messages associated with the authentication and connection establishment, to be forwarded by the relay UE to the RAN; or
an indication for the relay UE to create the plurality of messages associated with the authentication and connection establishment, and to send them to the RAN on behalf of the PRU.

In some embodiments, performing authentication and connection establishment with the RAN or with the peer UE that is out-of-coverage with respect to the RAN in block 1210 includes the operations of block 1212, where the PRU sends the one or more identifiers associated with the PRU to the RAN or to the peer UE during the authentication or the connection establishment.

In some embodiments, the one or more identifiers associated with the PRU include a PRU identifier (PRU ID) and a layer-2 SL identifier (SL L2 ID). In other embodiments, the one or more identifiers associated with the PRU are temporary or local identifiers not assigned by the RAN, and the exemplary method also includes the operations of block 1250, where the PRU determines updated values for the temporary or local identifiers in response to one or more of the following:
expiration of a validity timer;
a SL discovery request from another UE;
a radio link failure (RLF) on the SL and/or on a link with the RAN;
an update request from the RAN or from the UE; and.
initiation of a handover of the PRU to a different cell in the RAN.

In various embodiments, the positioning-related operations performed by the PRU in block 1240 can include any of the following, labelled with corresponding sub-block numbers:
(1241) transmitting SL RS for measurement by the UE;
(1242) measuring SL RS transmitted by the UE;
(1243) receiving positioning measurements from the UE via the SL; and
(1244) sending positioning assistance data to the UE via the SL.

In addition, FIG. 13 shows an exemplary method (e.g., procedure) for a RAN node configured to support SL communication between UEs, according to various embodiments of the present disclosure. The exemplary method can be performed by a RAN node (e.g., base station, eNB, gNB, en-gNB, etc.) such as described elsewhere herein.

The exemplary method can include the operations of block 1310, where for each of one or more PRUs, the RAN node can obtain one or more identifiers associated with the PRU. The exemplary method can also include the operations of block 1330, where the RAN node can transmit in a unicast or encrypted broadcast message an indication of whether each of the PRUs has been authenticated for positioning-related operations with UEs. The indications for the respective PRUs are based on the identifiers associated with the respective PRUs.

In some embodiments, the indication comprises the one or more identifiers associated with each of the PRUs that is trustworthy for positioning-related operations with UEs. In some of these embodiments, each of the PRUs is trustworthy based on authentication of the PRU with the RAN or with a core network connected to the RAN. FIG. 9 shows an example of these embodiments.

In other embodiments, obtaining one or more identifiers associated with each of one or more PRUs in block 1310 includes the operations of sub-block 1311, where the RAN node can receive from a UE first and second identifiers associated with a first PRU. For example, the first and second identifiers can be a PRU identifier (PRU ID) and a layer-2 SL identifier (SL L2 ID), in either order. In such embodiments, the exemplary method can also include the operations of block 1320, where the RAN node can determine whether the first PRU is trustworthy based on a mapping between corresponding first and second identifiers for PRUs that have been authenticated for positioning-related operations with UEs.

In some of these embodiments, the indication is transmitted to the UE (e.g., in block 1330) in a unicast message and when the first PRU is determined to be trustworthy for positioning-related operations with UEs (e.g., in block 1320), the indication comprises a SL configuration for establishing a SL connection between the UE and the first PRU. For example, the inclusion of the SL configuration can indicate that the first PRU is trustworthy (e.g., based on having been authenticated). FIG. 10 shows an example of these embodiments.

In various embodiments, each of the PRUs is trustworthy for one or more of the following positioning-related operations with UEs:
transmitting SL RS for measurement by UEs;
measuring SL RS transmitted by UEs;
receiving positioning measurements from UEs via SL; and
sending positioning assistance data to UEs via SL.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

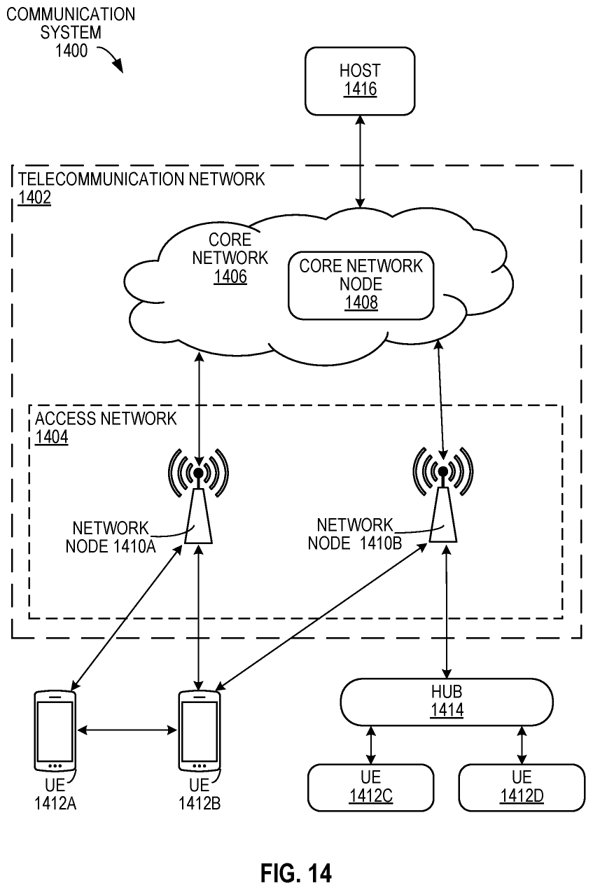

FIG. 14 shows an example of a communication system 1400 in accordance with some embodiments. In this example, the communication system 1400 includes a telecommunication network 1402 that includes an access network 1404, such as a radio access network (RAN), and a core network 1406, which includes one or more core network nodes 1408. Access network 1404 includes one or more access network nodes, such as network nodes 1410a and 1410b (one or more of which may be generally referred to as network nodes 1410), or any other similar 3GPP access node or non-3GPP access point. Network nodes 1410 facilitate direct or indirect connection of UEs, such as by connecting UEs 1412a-d (one or more of which may be generally referred to as UEs 1412) to core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

UEs 1412 may be any of a wide variety of communication devices, including wireless devices arranged, configured, and/or operable to communicate wirelessly with network nodes 1410 and other communication devices. Similarly, network nodes 1410 are arranged, capable, configured, and/or operable to communicate directly or indirectly with UEs 1412 and/or with other network nodes or equipment in telecommunication network 1402 to enable and/or provide network access, such as wireless network access, and/or to perform other functions, such as administration in telecommunication network 1402.

In the depicted example, core network 1406 connects network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1416 may be under the ownership or control of a service provider other than an operator or provider of access network 1404 and/or telecommunication network 1402 and may be operated by the service provider or on behalf of the service provider. Host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1402 is a cellular network that implements 3GPP standardized features. Accordingly, telecommunications network 1402 may support network slicing to provide different logical networks to different devices that are connected to telecommunication network 1402. For example, telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1412 are configured to transmit and/or receive information without direct human interaction. For instance, a UE may be designed to transmit information to access network 1404 on a predetermined schedule, when triggered by an internal or external event, or in response to requests from access network 1404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, hub 1414 may be a broadband router enabling access to the core network 1406 for the UEs. As another example, hub 1414 may be a controller that sends commands or instructions to one or more actuators in the UEs. Commands or instructions may be received from the UEs, network nodes 1410, or by executable code, script, process, or other instructions in hub 1414. As another example, hub 1414 may be a data collector that acts as temporary storage for UE data and, in some embodiments, may perform analysis or other processing of the data. As another example, hub 1414 may be a content source. For example, for a UE that is a VR headset, display, loudspeaker or other media delivery device, hub 1414 may retrieve VR assets, video, audio, or other media or data related to sensory information via a network node, which hub 1414 then provides to the UE either directly, after performing local processing, and/or after adding additional local content. In still another example, hub 1414 acts as a proxy server or orchestrator for the UEs, in particular in if one or more of the UEs are low energy IoT devices.

Hub 1414 may have a constant/persistent or intermittent connection to the network node 20) 1410b. Hub 1414 may also allow for a different communication scheme and/or schedule between hub 1414 and UEs (e.g., UE 1412c and/or 1412d), and between hub 1414 and core network 1406. In other examples, hub 1414 is connected to core network 1406 and/or one or more UEs via a wired connection. Moreover, hub 1414 may be configured to connect to an M2M service provider over access network 1404 and/or to another UE over a direct connection. In some scenarios, UEs may establish a wireless connection with network nodes 1410 while still connected via hub 1414 via a wired or wireless connection. In some embodiments, hub 1414 may be a dedicated hub—that is, a hub whose primary function is to route communications to/from the UEs from/to the network node 1410b. In other embodiments, hub 1414 may be a non-dedicated hub—that is, a device which is capable of operating to route communications between the UEs and network node 1410b, but which is additionally capable of operating as a communication start and/or end point for certain data channels.

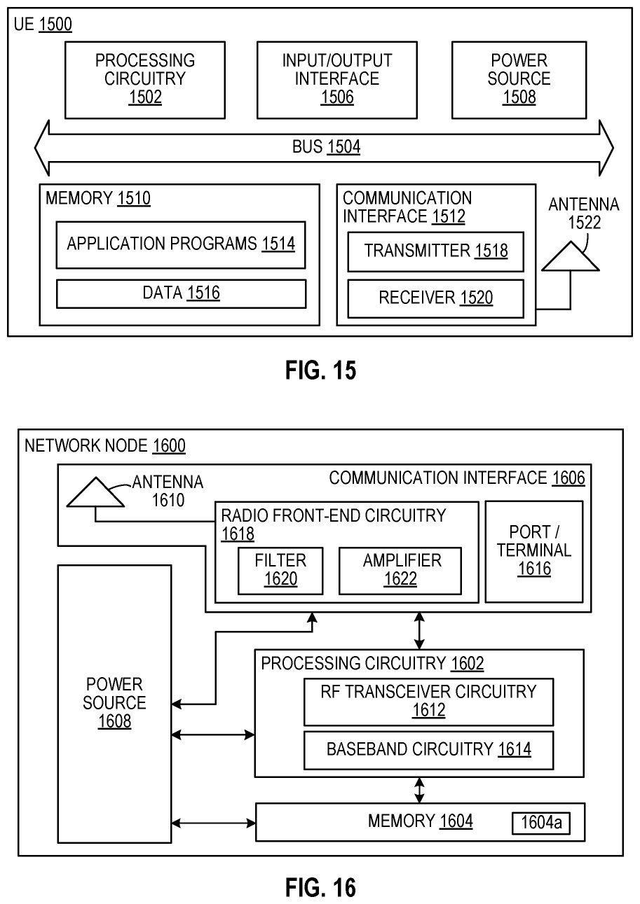

FIG. 15 shows a UE 1500 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1500 includes processing circuitry 1502 that is operatively coupled via bus 1504 to input/output interface 1506, power source 1508, memory 1510, communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

Processing circuitry 1502 is configured to process instructions and data and may be configured to implement any sequential state machine operative to execute instructions stored as machine-readable computer programs in memory 1510. Processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1508 is structured as a battery or battery pack. Other types of power sources, such as an external power source (e.g., an electricity outlet), photovoltaic device, or power cell, may be used. Power source 1508 may further include power circuitry for delivering power from power source 1508 itself, and/or an external power source, to the various parts of UE 1500 via input circuitry or an interface such as an electrical power cable. Delivering power may be, for example, for charging of power source 1508. Power circuitry may perform any formatting, converting, or other modification to the power from power source 1508 to make the power suitable for the respective components of UE 1500 to which power is supplied.

Memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1510 includes one or more application programs 1514, such as an operating system, web browser application, a widget, gadget engine, or other application, and corresponding data 1516. Memory 1510 may store, for use by UE 1500, any of a variety of various operating systems or combinations of operating systems.

Memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1510 may allow UE 1500 to access instructions, application programs and the like, stored on transitory or non-transitory memory media, to off-load data, or to upload data. An article of manufacture, such as one utilizing a communication system may be tangibly embodied as or in memory 1510, which may be or comprise a device-readable storage medium.

Processing circuitry 1502 may be configured to communicate with an access network or other network using communication interface 1512, which may comprise one or more communication subsystems and may include or be communicatively coupled to antenna 1522. Communication interface 1512 may include one or more transceivers used to communicate, such as by communicating with one or more remote transceivers of another device capable of wireless communication (e.g., another UE or a network node in an access network). Each transceiver may include transmitter 1518 and/or receiver 1520 appropriate to provide network communications (e.g., optical, electrical, frequency allocations, and so forth). Moreover, transmitter 1518 and receiver 1520 may be coupled to one or more antennas (e.g., antenna 1522) and may share circuit components, software or firmware, or alternatively be implemented separately.

In the illustrated embodiment, communication functions of communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions (collectively denoted computer program product 1604a) capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

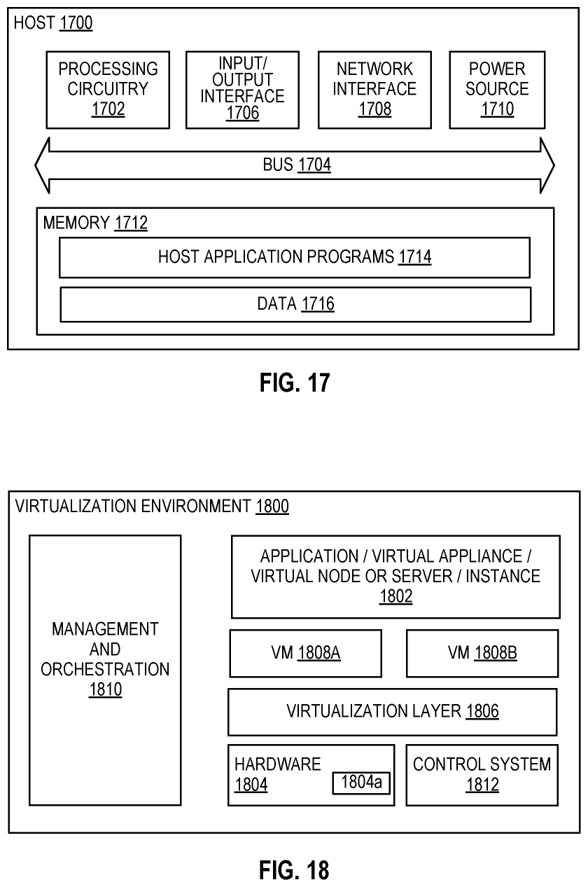

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions (collectively denoted computer program product 1804a) executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

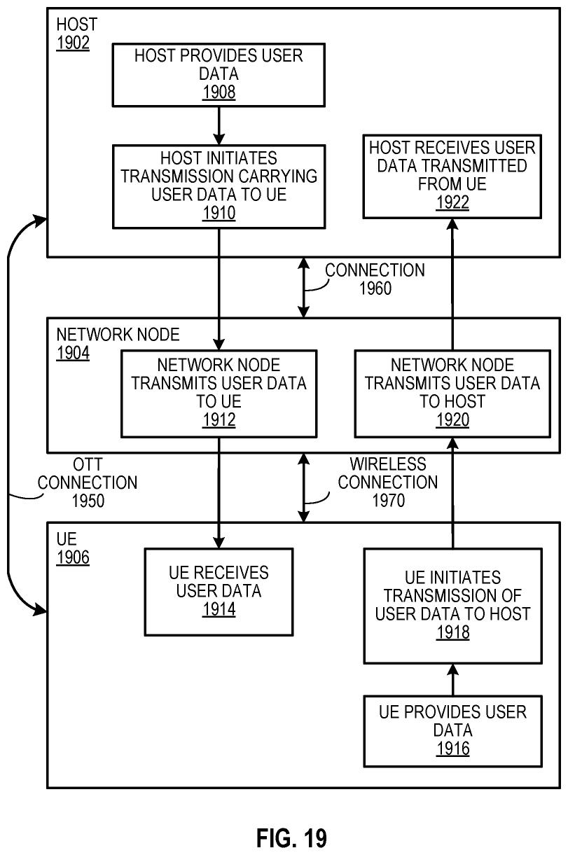

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, embodiments described herein ensure that PRU usage is secure, such that networks and UEs first determine that a node claiming to be a PRU has been authenticated (or is otherwise trustworthy) before using the node/PRU for positioning-related operations. In this manner, embodiments avoid and/or prevent risks that malicious PRUs pose to both UEs and networks and generally improve the security of positioning-related procedures involving PRUs. Accordingly, embodiments increases the value of OTT services that rely on SL positioning to both end users and services providers.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above or by supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:
A1. A method for a user equipment (UE) configured for sidelink (SL) communication in a radio access network (RAN), the method comprising:
   receiving an indication of whether one or more proximate positioning reference units (PRUs) are trustworthy for positioning-related operations;
   based on the indication, determining that a first one of the PRUs is trustworthy; and
   establishing a SL with the first PRU and performing positioning-related operations with the first PRU via the SL.
A2. The method of embodiment A1, wherein the indication is received from a RAN node via one of the following: a unicast message or an encrypted broadcast message.
A3. The method of embodiment A1, wherein:
   the UE is out-of-coverage with respect to the RAN; and
   the indication is received via SL from one or more peer UEs, each being in-coverage or out-of-coverage with respect to the RAN.
A2. The method of any of embodiments A1-A3, wherein the indication comprises respective identifiers associated with one or more PRUs that are trustworthy.
A4. The method of any of embodiments A1-A3, further comprising:
   sending a SL discovery request indicating a need for positioning-related operations;
   receiving, from the first PRU, a responsive message including one or more identifiers associated with the first PRU; and
   sending the one or more identifiers to one or more nodes in the RAN, wherein the indication indicates that the first PRU is trustworthy.
A5. The method of embodiment A4, wherein:
   the indication comprises a SL configuration; and
   the SL is established with the first PRU based on the SL configuration.
A6. The method of embodiment A4, wherein:
   the one or more identifiers are sent in a SL discovery message during a SL discovery procedure;
   the SL discovery message indicates that the SL discovery procedure is for determining whether the first PRU is trustworthy; and
   the indication comprises respective indications received from one or more peer UEs in response to the SL discovery message.
A7. The method of embodiment A6, wherein determining that the first PRU is trustworthy is based on a predetermined number or portion of the received indications indicating that the first PRU is trustworthy.
A8. The method of embodiment A7, wherein the predetermined portion is all of the received indications.
A9. The method of any of embodiments A4-A8, wherein the one or more identifiers include a PRU identifier (PRU ID) and a layer-2 SL identifier (SL L2 ID).
A10. The method of any of embodiments A1-A9, wherein the positioning-related operations include one or more of the following:
   transmitting SL reference signals (RS) for measurement by the first PRU;
   measuring SL RS transmitted by the first PRU;
   sending positioning measurements to the first PRU via the SL; and
   receiving positioning assistance data from the first PRU via the SL.
B1. A method for a positioning reference unit (PRU) configured for sidelink (SL) communication in a radio access network (RAN), the method comprising:
   performing authentication and connection establishment with the RAN or with a peer UE;
   receiving, from a UE, a SL discovery request indicating a need for positioning-related operations;
   in response to the SL discovery request, sending to the UE one or more identifiers associated with the PRU; and
   subsequently establishing a SL with the UE and performing positioning-related operations with the UE via the SL.
B2. The method of embodiment B1, wherein:
   the PRU is out-of-coverage with respect to the RAN; and
   the authentication and connection establishment is performed with the RAN via a relay UE that is in-coverage with respect to the RAN.
B3. The method of embodiment B2, wherein performing authentication and connection establishment comprises sending one of the following to the relay UE:
   a plurality of messages associated with the authentication and connection establishment, to be forwarded by the relay UE to the RAN; or
   an indication that the relay UE should create the plurality of messages and send them on behalf of the PRU.
B4. The method of any of embodiments B1-B3, wherein the PRU provides the one or more associated identifiers to the RAN or to the peer UE during authentication and/or connection establishment.
B5. The method of any of embodiments B1-B4, wherein the one or more identifiers include a PRU identifier (PRU ID) and a layer-2 SL identifier (SL L2 ID).
B6. The method of any of embodiments B1-B4, wherein:
   the one or more identifiers are temporary or local identifiers not assigned by the RAN; and
   the method further comprises determining updated values for the temporary or local identifiers in response to one or more of the following:
      expiration of a validity timer;
      a SL discovery request from another UE;
      a radio link failure (RLF) on the SL and/or on a link with the RAN;
      an update request from the RAN or from the UE; and initiation of a handover of the PRU to a different cell in the RAN.
B7. The method of any of embodiments B1-B6, wherein the positioning-related operations include one or more of the following:
   transmitting SL reference signals (RS) for measurement by the UE;
   measuring SL RS transmitted by the UE;
   receiving positioning measurements from the UE via the SL; and
   sending positioning assistance data to the UE via the SL.
C1. A method for a radio access network (RAN) node configured to support sidelink (SL) communication between user equipment (UEs), the method comprising:
   for each of one or more positioning reference units (PRUs), obtaining one or more associated identifiers; and
   transmitting an indication of whether each of the PRUs is trustworthy for positioning-related operations by UEs.
C2. The method of embodiment C1, wherein each of the PRUs is trustworthy based on authentication of the PRU with the RAN or with a core network connected to the RAN.
C3. The method of embodiment C2, wherein:
   the indication comprises the one or more identifiers associated with each of the PRUs that is trustworthy; and
   the indication is transmitted via a unicast message or an encrypted broadcast message.
C5. The method of embodiment C1, wherein:
   the one or more identifiers include first and second identifiers associated with a first PRU;
   the first and second identifiers are received from a UE; and
   the method further comprises determining whether the first PRU is trustworthy based on a mapping between corresponding first and second identifiers for trustworthy PRUs.
C6. The method of embodiment C5, wherein:
   the indication is transmitted to the UE; and
   when the first PRU is determined to be trustworthy, the indication comprises a SL configuration for establishing a SL connection between the UE and the first PRU.
C7. The method of any of embodiments C1-C6, wherein the one or more identifiers associated with each of the PRUs include a PRU identifier (PRU ID) and a layer-2 SL identifier (SL L2 ID).
C8. The method of any of embodiments C1-C7, wherein the positioning-related operations include one or more of the following:
   measuring SL reference signals (RS) transmitted by the PRU;
   transmitting SL RS to be measured by the PRU;
   sending positioning measurements to the PRU via a SL; and
   receiving positioning assistance data from the PRU via a SL.
D1. A user equipment (UE) configured for sidelink (SL) communication in a radio access network (RAN), the UE comprising:
   communication interface circuitry configured to communicate with a RAN node and via SL with other UEs; and
   processing circuitry operatively coupled to the communication interface circuitry, whereby the processing circuitry and the communication interface circuitry are configured to perform operations corresponding to any of the methods of embodiments A1-A10.
D2. A user equipment (UE) configured for sidelink (SL) communication in a radio access network (RAN), the UE being further configured to perform operations corresponding to any of the methods of embodiments A1-A10.
D3. A non-transitory, computer-readable medium storing computer-executable instructions that, when executed by processing circuitry of a user equipment (UE) configured for sidelink (SL) communication in a radio access network (RAN), configure the UE to perform operations corresponding to any of the methods of embodiments A1-A10.
D4. A computer program product comprising computer-executable instructions that, when executed by processing circuitry of a user equipment (UE) configured for sidelink (SL) communication in a radio access network (RAN), configure the UE to perform operations corresponding to any of the methods of embodiments A1-A10.
E1. A positioning reference unit (PRU) configured for sidelink (SL) communication in a radio access network (RAN), the PRU comprising:
   communication interface circuitry configured to communicate with a RAN node and via SL with user equipment (UEs); and
   processing circuitry operatively coupled to the communication interface circuitry, whereby the processing circuitry and the communication interface circuitry are configured to perform operations corresponding to any of the methods of embodiments B1-B7.
E2. A positioning reference unit (PRU) configured for sidelink (SL) communication in a radio access network (RAN), the PRU being further configured to perform operations corresponding to any of the methods of embodiments B1-B7.
E3. A non-transitory, computer-readable medium storing computer-executable instructions that, when executed by processing circuitry of a positioning reference unit (PRU) configured for sidelink (SL) communication in a radio access network (RAN), configure the PRU to perform operations corresponding to any of the methods of embodiments B1-B7.
E4. A computer program product comprising computer-executable instructions that, when executed by processing circuitry of a positioning reference unit (PRU) configured for sidelink (SL) communication in a radio access network (RAN), configure the PRU to perform operations corresponding to any of the methods of embodiments B1-B7.
F1. A radio access network (RAN) node configured to support sidelink (SL) communication between user equipment (UEs), the RAN node comprising:
   communication interface circuitry configured to communicate with the UEs; and
   processing circuitry operatively coupled to the communication interface circuitry, whereby the processing circuitry and the communication interface circuitry are configured to perform operations corresponding to any of the methods of embodiments C1-C8.
F2. A radio access network (RAN) node configured to support sidelink (SL) communication between user equipment (UEs), the RAN node being further configured to perform operations corresponding to any of the methods of embodiments C1-C8.
F3. A non-transitory, computer-readable medium storing computer-executable instructions that, when executed by processing circuitry of a radio access network (RAN) node configured to support sidelink (SL) communication between user equipment (UEs), configure the RAN node to perform operations corresponding to any of the methods of embodiments C1-C8.
F4. A computer program product comprising computer-executable instructions that, when executed by processing circuitry of a radio access network (RAN) node configured to support sidelink (SL) communication between user equipment (UEs), configure the RAN node to perform operations corresponding to any of the methods of embodiments C1-C8.

1.-43. (canceled)

44. A method for a user equipment (UE) configured for sidelink (SL) communication in a radio access network (RAN), the method comprising:
receiving an indication of whether one or more positioning reference units (PRUs) are trustworthy for positioning-related operations with UEs;
based on the indication, determining that a first one of the PRUs is trustworthy for positioning-related operations with UEs; and
based on determining that the first PRU is trustworthy, establishing a SL with the first PRU and performing positioning-related operations with the first PRU via the SL.

45. The method of claim 44, wherein one of the following applies:
the indication is received from a RAN node via a unicast message or an encrypted broadcast message; or
the UE is out-of-coverage with respect to the RAN and the indication is received via SL from one or more peer UEs, with each peer UE being in-coverage or out-of-coverage with respect to the RAN.

46. The method of claim 44, wherein the indication comprises respective identifiers associated with the one or more PRUs, with each identifier indicating that the associated PRU is trustworthy for positioning-related operations with UEs.

47. The method of claim 44, further comprising:
sending a SL discovery request indicating a need for positioning-related operations;
receiving from the first PRU a responsive message including one or more identifiers associated with the first PRU.

48. The method of claim 47, wherein the one or more identifiers associated with the first PRU include a PRU identifier (PRU ID) and a layer-2 SL identifier (SL L2 ID).

49. The method of claim 47, further comprising sending the one or more identifiers associated with the first PRU to a RAN node, wherein:
the indication is received from the RAN node in response to sending the one or more identifiers associated with the first PRU, and
the indication indicates that the first PRU is trustworthy based on having been authenticated by the RAN or by a core network connected to the RAN.

50. The method of claim 49, wherein:
the indication from the RAN node comprises a SL configuration for establishing a SL connection with the first PRU, which indicates that the first PRU is trustworthy for positioning-related operations with UEs; and
the SL is established with the first PRU based on the SL configuration.

51. The method of claim 47, further comprising sending the one or more identifiers associated with the first PRU in a SL discovery message during a SL discovery procedure, wherein:
the SL discovery message indicates that the SL discovery procedure is for determining whether the first PRU is trustworthy for positioning-related operations with UEs; and
the indication comprises respective indications received from one or more peer UEs in response to the SL discovery message.

52. The method of claim 51, wherein determining that the first PRU is trustworthy is based on a predetermined number or portion of the respective indications received from the one or more peer UEs indicating that the first PRU is trustworthy for positioning-related operations with UEs.

53. The method of claim 52, wherein the predetermined portion is all of the indications received from the one or more peer UEs.

54. The method of claim 44, wherein the positioning-related operations performed by the UE include one or more of the following:
transmitting SL reference signals (RS) for measurement by the first PRU;
measuring SL RS transmitted by the first PRU;
sending positioning measurements to the first PRU via the SL; and
receiving positioning assistance data from the first PRU via the SL.

55. A method for a radio access network (RAN) node configured to support sidelink (SL) positioning by user equipment (UEs), the method comprising:
for each of one or more positioning reference units (PRUs), obtaining one or more identifiers associated with the PRU; and
transmitting, in a unicast or encrypted broadcast message, an indication of whether each of the PRUs is trustworthy for positioning-related operations with UEs, wherein the indications for the respective PRUs are based on the identifiers associated with the respective PRUs.

56. The method of claim 55, wherein for each of the PRUs, the one or more identifiers associated with the PRU include a PRU identifier (PRU ID) and a SL layer-2 identifier (SL L2 ID).

57. The method of claim 55, wherein the indication comprises the one or more identifiers associated with each of the PRUs that is trustworthy for positioning-related operations with UEs.

58. The method of claim 57, wherein each of the PRUs is trustworthy based on authentication of the PRU by the RAN or by a core network connected to the RAN.

59. The method of claim 55, wherein:
obtaining one or more identifiers associated with each of one or more PRUs comprises receiving from a UE first and second identifiers associated with a first PRU; and
the method further comprises determining whether the first PRU is trustworthy based on a mapping between corresponding first and second identifiers associated with PRUs that have been authenticated for positioning-related operations with UEs.

60. The method of claim 59, wherein:
the indication is transmitted to the UE in a unicast message; and
when the first PRU is determined to be trustworthy for positioning-related operations with UEs, the indication comprises a SL configuration for establishing a SL connection between the UE and the first PRU.

61. The method of claim 55, wherein each of the PRUs is trustworthy for one or more of the following positioning-related operations with UEs:
transmitting SL reference signals (RS) for measurement by UEs;
measuring SL RS transmitted by UEs;
receiving positioning measurements from UEs via SL; and
sending positioning assistance data to UEs via SL.

62. A user equipment (UE) configured for sidelink (SL) communication in a radio access network (RAN), the UE comprising:
communication interface circuitry configured to communicate with a RAN node and via SL with positioning reference units (PRUs); and
processing circuitry operatively coupled to the communication interface circuitry, wherein the processing circuitry and the communication interface circuitry are configured to:
receive an indication of whether one or more PRUs are trustworthy for positioning-related operations with UEs;
based on the indication, determine that a first one of the PRUs is trustworthy for positioning-related operations with UEs; and
based on determining that the first PRU is trustworthy, establish a SL with the first PRU and perform positioning-related operations with the first PRU via the SL.

63. A radio access network (RAN) node configured to support sidelink (SL) positioning by user equipment (UEs), the RAN node comprising:
communication interface circuitry configured to communicate with UEs and with positioning reference units (PRUs); and
processing circuitry operatively coupled to the communication interface circuitry, wherein the processing circuitry and the communication interface circuitry are configured to:
for each of one or more PRUs, obtain one or more identifiers associated with the PRU; and
transmit, in a unicast or encrypted broadcast message, an indication of whether each of the PRUs is trustworthy for positioning-related operations with UEs, wherein the indications for the respective PRUs are based on the identifiers associated with the respective PRUs.
